(19) United States
(12) Patent Application Publication
(10) Pub. No.: US 2025/0306354 A1
(43) Pub. Date: Oct. 2, 2025

(54) POWER SUPPLY FOR A MICROSCOPE SYSTEM

(71) Applicant: CARL ZEISS MICROSCOPY GMBH, Jena (DE)

(72) Inventors: Martin MUELLER, Jena (DE); Simon LEITSCH, München (DE)

(21) Appl. No.: 19/092,055

(22) Filed: Mar. 27, 2025

(30) Foreign Application Priority Data
Mar. 27, 2024 (DE) 102024108875.3

(51) Int. Cl. G02B 21/26; G02B 21/24; H02M 7/00; H02M 7/04

(52) U.S. Cl. CPC G02B 21/26; G02B 21/241; H02M 7/003; H02M 7/04

(57) ABSTRACT

The current disclosure provides a microscope system for analyzing samples, comprising: an optical microscope unit; a power supply for mains electric power; at least one alternating current load which is supplied with mains electric power via the power supply; at least one direct current load; a power supply unit which is set up to convert the mains electric power from the power supply into direct current, wherein the at least one direct current load is supplied with direct current via the power supply unit; and at least one electric main switch which is arranged in the power supply and which is set up to interrupt the mains electric power for the at least one alternating current load and the power supply unit. In at least some embodiments, the at least one electric main switch is in a manual switch.

### CROSS-REFERENCE TO RELATED APPLICATION

This application claims the benefit of German Patent Application No. DE 10 2024 108 875.3 filed Mar. 27, 2024, the entire contents of which is incorporated herein by reference in its entirety.

### FIELD

The invention relates to a microscope system for analyzing samples, wherein the microscope system comprises an optical microscope unit, a power supply for mains electric power, at least one alternating current load which is supplied with mains electric power via the power supply, at least one direct current load and a power supply unit which is set up to convert the mains electric power from the power supply into direct current.

### BACKGROUND

Modern microscope systems, such as widefield microscopes, confocal microscopes, super resolution microscopes, light sheet microscopes and digital microscopes, have a large number of components that are powered by electric power. These components can be divided into direct current loads and alternating current loads and must be supplied with the respectively appropriate type of current.

Document EP 2 101 210 A2 (which is incorporated herein by reference in its entirety) relates to an observation system comprising an observation device and an operating device, wherein the observation device and the operating device each comprise a power source unit, wherein the operating device comprises an operating unit which is adapted to remotely control the observation device, and the observation device comprises at least one electrically driven unit comprising a motor, a control unit which is adapted to control the electrically driven unit, a first power supply line which is used for supplying the electrically driven unit with electric power from the power source unit, a switching unit which is arranged on the first power supply line and which is used for switching the power supply for the electrically driven unit on or off, and a second power supply line which is used for supplying the control unit with electric power from the power source unit.

Document JP 2020 086266 A (which is incorporated herein by reference in its entirety) relates to an observation apparatus with a power supply arrangement.

### SUMMARY

It is an object of the present disclosure to provide an improved microscope system. In particular, it is an object to improve the power supply of the microscope system.

This object is achieved by a microscope system according to claim 1. Advantageous embodiments are claimed in the dependent claims.

A first aspect of the disclosure relates to a microscope system for analyzing samples, comprising:
an optical microscope unit;
a power supply for mains electric power;
at least one alternating current load which is supplied with mains electric power via the power supply;
at least one direct current load;
a power supply unit which is set up to convert the mains electric power from the power supply into direct current, wherein the at least one direct current load is supplied with direct current via the power supply unit; and
at least one electric main switch, in particular at least one manual electric main switch, which is arranged in the power supply and which is set up to interrupt the mains electric power for the at least one alternating current load and the power supply unit.

In at least one embodiment, the power supply is the only power supply of the microscope system. In one or more embodiment, the microscope system comprises a plurality of direct current loads and/or a plurality of alternating current loads.

A second aspect of the disclosure relates to a method of operating a microscope system, wherein a predefined switch-on sequence is maintained when the various loads are switched on by a control unit, in such a way that the loads can find each other.

The disclosure is based on the idea of operating a complex, modern microscope system with a single power supply. Here, the power supply provides all the voltages required for various components of the microscope system.

By providing an electric main switch in the power supply, which supplies the alternating current loads and the direct current loads of the microscope system with electric energy, the entire microscope system can be switched on or off by operating the electric main switch. In at least one embodiment, the electric main switch is manually operated. In this context, the power supply formed in this way can supply the entire microscope system with power. Here, the supply of energy by the power supply can be connected to a standard mains voltage, in particular an alternating current voltage of 230 V in Europe. No additional power supply units or cabling is required. This means that a particularly simple and uncluttered power supply can be achieved for the entire microscope system.

By specifying a predefined switch-on sequence, various loads can be switched on in the order which they rely on in order to interact with each other. In particular, the individual loads, which represent components of the microscope system, can be referenced to one another and calibrated one after the other by switching them on sequentially.

In at least one embodiment, the microscope system further comprises:
at least one alternating current switch which is set up to interrupt the mains electric power for the at least one alternating current load; and
at least one direct current switch, which is set up to interrupt the direct current for the at least one direct current load.

In some embodiments, a separate alternating current switch is provided for each switchable alternating current load.

Additionally, or alternatively, in one or more embodiment a separate direct current switch is optionally provided for each switchable direct current load.

The alternating current switches and the direct current switches make it possible to activate and to deactivate all or individual alternating current loads and all or individual direct current loads, depending on how this makes sense for a switch-on sequence or a switch-off sequence.

In some embodiments, the microscope system further comprises a control unit which is supplied with direct current via the power supply unit and which is connected to the at least one alternating current switch and the at least one direct current switch in a manner which enables the transmission of signals, and wherein the control unit is set up to switch the at least one alternating current switch and the at least one direct current switch.

By means of the control unit, the alternating current switches and the direct current switches can be automated and operated.

In a further embodiment, the microscope system further comprises a control box in which the control unit, the power supply unit and the at least one direct current switch are arranged.

Optionally, at least one of the components from the following group of components are also arranged in the control box: control devices of the direct current loads, an alternating current switch, the main switch and a direct current load. In some embodiments, it is also possible to arrange any sub-combination of the components or all components from this group.

By arranging components of the microscope system in a control box, a particularly safe and uncluttered cabling of the microscope system can be achieved. In at least one embodiment, the control box is constructed in such a way that the components which are installed in the control box are accommodated in an EMC-compliant manner.

In a further embodiment of the microscope system, the control unit can also be connected, or is connected, to a computer system in a manner which enables the transmission of signals.

Optionally, in some embodiments, the control unit is set up to start up and shut down the computer system. By means of the signal connection between the microscope system and a computer system, the computer system can accordingly be started up and shut down by the control unit. In this regard, the starting up of the computer system can take place via what is referred to as “wake-up” commands, which are sent to the computer system via the signal-transmitting connection, in particular a network or USB. During shutting down of the computer system, the control unit sends a corresponding “Go to Sleep” command to the computer system.

Conversely, a temporal sequence in which the control unit switches the alternating current switches and the direct current switches can be specified by means of the computer system. In some embodiments, the control unit is set up to directly execute commands from the computer system to switch on and off the at least one alternating current load and the at least one direct current load, so that the at least one alternating current load and the at least one direct current load are switched directly. In one or more embodiment, the sequence can be set in the control unit, in particular in a control file in a data memory of the control unit.

In a further embodiment of the microscope system, the control unit accordingly comprises a data memory in which a relative and/or absolute sequence, in particular a relative and/or absolute temporal sequence, for switching on and/or for switching off the at least one alternating current load and the at least one direct current load is stored, in particular in a control file, and wherein the control unit switches the at least one alternating current switch and the at least one direct current switch on the basis of this sequence.

By providing a data memory in the control unit, commands for switching on and off the at least one alternating current load and the at least one direct current load can be stored. The control unit can then be programmed in such a way that it carries out the activation and/or the deactivation of the individual loads in a sequence on the basis of predefined criteria and/or on the basis of a predefined temporal sequence. In this context, the temporal sequence can be set using the computer system.

In particular, it may be necessary to maintain a certain switch-on sequence when the various components are switched on so that the components can find each other. Similarly, a defined switch-off sequence may be required when switching off. Both sequences can be implemented using the predefined switch-on/switch-off control. In addition, a staggered switch-on can also have a positive effect on switching currents on a secondary side of the power supply unit.

In a further embodiment of the microscope system, the at least one alternating current load is selected from the following group of alternating current loads: a first light, a second light, an XY stage with control system, an incubation unit, a manipulation unit for microscopic samples, equipment for electrophysiology and a laser microscope unit. Optionally, it is also possible to select any sub-combination of the alternating current loads or all alternating current loads from the group.

In this context, the alternating current loads can be components which are integrated into the optical microscope unit, as well as external components.

In a further embodiment of the microscope system, the at least one direct current load is selected from the following group of direct current loads: Stand, focus drive, trigger unit, definite focus unit, auto-immersion unit, third light, incubator and piezo focus unit. Optionally, it is also possible to select any sub-combination of the direct current loads or all direct current loads from the group.

In some embodiments, the direct current loads are integrated into the optical microscope unit.

In a further embodiment of the microscope system, the definite focus unit is switched on after the stand in accordance with the stored switch-on sequence, and/or the definite focus unit is switched on after the control unit in accordance with the stored sequence.

In a corresponding manner, in a further embodiment of the method, the definite focus unit is switched on after the stand in accordance with the stored switch-on sequence, and/or the definite focus unit is switched on after the control unit in accordance with the stored switch-on sequence.

This switching sequence allows the control system of the definite focus unit to access functions in the stand.

In a further embodiment of the microscope system, the stand is switched off after the definite focus unit in accordance with the stored switch-off sequence and/or the main board is switched off after the definite focus unit in accordance with the stored sequence.

In a corresponding manner, in a further embodiment of the method, the stand is switched off after the definite focus unit and/or the main board is switched off after the definite focus unit in accordance with the stored sequence.

As a result of this switching sequence, the necessary information from the stand is available to control system of the definite focus unit at all times. In this way, a situation can be prevented in which the control system of the definite focus does not work correctly for a short period of time.

One aspect of the disclosure comprises any one or more of the aspects/embodiments as substantially disclosed herein.

Another aspect of the disclosure is any one or more of the aspects/embodiments as substantially disclosed herein optionally in combination with any one or more other aspects/embodiments as substantially disclosed herein.

It is another aspect of the present disclosure to provide one or more means adapted to perform any one or more of the above aspects/embodiments as substantially disclosed herein.

The Summary is neither intended nor should it be construed as being representative of the full extent and scope of the present disclosure. The present disclosure is set forth in various levels of detail in the Summary as well as in the attached drawings and the Detailed Description and no limitation as to the scope of the present disclosure is intended by either the inclusion or non-inclusion of elements, components, etc. in this Summary. Additional aspects of the present disclosure will become more clear from the Detailed Description, particularly when taken together with the drawings.

The phrases “at least one,” “one or more,” and “and/or,” as used herein, are open-ended expressions that are both conjunctive and disjunctive in operation. For example, each of the expressions “at least one of A, B and C,” “at least one of A, B, or C,” “one or more of A, B, and C,” “one or more of A, B, or C,” and “A, B, and/or C” means A alone, B alone, C alone, A and B together, A and C together, B and C together, or A, B and C together.

The term “a” or “an” entity, as used herein, refers to one or more of that entity. As such, the terms “a” (or “an”), “one or more” and “at least one” can be used interchangeably herein.

Unless otherwise indicated, all numbers expressing quantities, dimensions, conditions, ratios, ranges, and so forth used in the specification and claims are to be understood as being modified in all instances by the term “about” or “approximately”. When used with a number or a range, the terms “about” and “approximately” indicate the number or range may be “a little above” or “a little below” the endpoint with a degree of flexibility as would be generally recognized by those skilled in the art. Further, the terms “about” and “approximately” may include the exact endpoint, unless specifically stated otherwise. Accordingly, unless otherwise indicated, all numbers expressing quantities, dimensions, conditions, ratios, angles, ranges, and so forth used in the specification and claims may be increased or decreased by approximately 5% to achieve satisfactory results. Additionally, where the meaning of the terms “about” or “approximately” as used herein would not otherwise be apparent to one of ordinary skill in the art, the terms “about” and “approximately” should be interpreted as meaning within plus or minus 10% of the stated value.

The use of “including,” “comprising,” or “having” and variations thereof herein is meant to encompass the items listed thereafter and equivalents thereof as well as additional items. Accordingly, the terms “including,” “comprising,” or “having” and variations thereof can be used interchangeably herein.

It shall be understood that the term “means” as used herein shall be given its broadest possible interpretation in accordance with 35 U.S.C., Section 112(f). Accordingly, a claim incorporating the term “means” shall cover all structures, materials, or acts set forth herein, and all of the equivalents thereof. Further, the structures, materials, or acts and the equivalents thereof shall include all those described in the Summary, Brief Description of the Drawings, Detailed Description, Abstract, and Claims themselves.

### BRIEF DESCRIPTION OF THE DRAWINGS

Further features and advantages will be explained in the following description with reference to the figures. These show, at least partially schematically:

FIG. 1: shows a combined representation of a network diagram and a circuit diagram of an example embodiment of the microscope system for analyzing samples, as well as its switching and network environment; and

FIG. 2: shows a flowchart of an example embodiment of a method of operating a microscope system.

### DETAILED DESCRIPTION

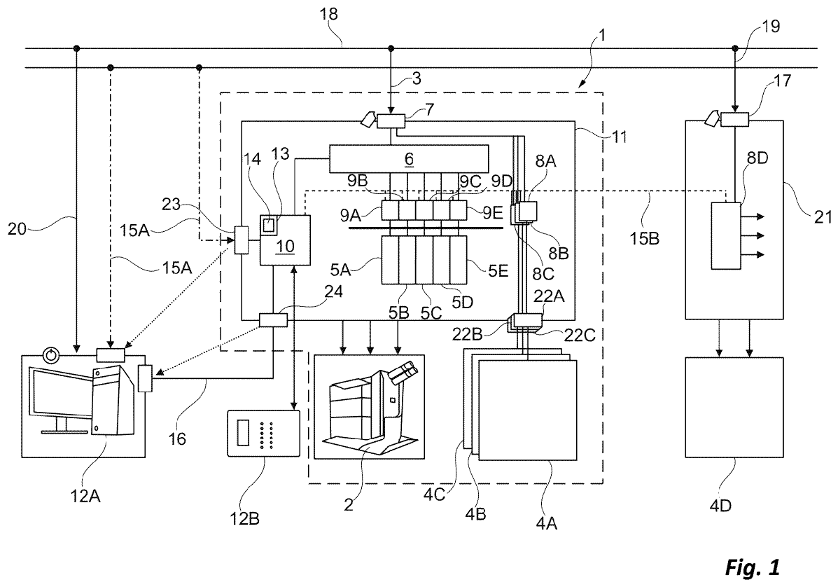

FIG. 1 is a combined representation of a network diagram and a circuit diagram of an example embodiment of the microscope system 1 for analyzing samples, as well as the switching and network environment of the microscope system 1.

The microscope system 1 comprises an optical microscope unit 2 as well as various direct current loads 5A, 5B, 50, 5D, 5E. Essentially, these direct current loads are components of the microscope system 1 that are used to operate the optical microscope unit 2. Examples of direct current loads are a stand, a focus drive, a trigger unit, a definite focus unit, an auto-immersion unit, a light, an incubator and also a piezo focus unit.

In addition, in some embodiments, the microscope system 1 optionally comprises various alternating current loads 4A, 4B, 4C. Optionally, these alternating current loads are components of the microscope system 1 that are also used to operate the optical microscope unit 2. However, these components are often not provided by the manufacturer of the optical microscope unit 2, but can respectively be added independently by users of the microscope system 1 in order to adapt the microscope system 1 to a desired application. Examples of such components are an XY stage with control system, an incubation unit, a manipulation unit for microscopic samples, equipment for electrophysiology, a laser microscope unit and a confocal microscope unit 2.

In addition, the microscope unit 1 optionally has a control unit 10, which is provided for control functions for the optical microscope unit 2 and other components of the microscope system 1. The control unit 10 can be designed as a microcontroller or also as what is referred to as an embedded personal computer.

The entire microscope system 1 is optionally supplied with electric power via a single power line 3, which serves as part of a power supply system. Optionally, this power line 3 is electrically connected to the mains 18 via a mains plug (not shown). Arranged in the power line 3 or in the power supply is a first main switch 7, with which the power supply to the microscope system 1 can be interrupted. In some embodiments, the entire supply of electric power to the microscope system 1 is interrupted by means of the main switch 7. In particular, all electric loads are disconnected from the supply of electric power by switching the main switch 7.

A power supply unit 6 is connected to the power supply 3. This power supply unit 6 supplies, via another power line, electric power to the control unit 10 as well as the components which are constructed as direct current loads. In this regard, the direct current loads can optionally be switched via at least one direct current switch 9A, 9B, 9C, 9D, 9E. Further, in some embodiments, an individual direct current switch is provided for each of the switchable direct current loads or at least for groups of a plurality of direct current loads. In this way, individual direct current loads or groups of direct current loads can selectively be activated and deactivated. The direct current switches are optionally constructed as semiconductor switches, in particular metal-oxide-semiconductor field-effect transistors (MOSFETs), or as mechanical relays.

The components which are constructed as alternating current loads can be connected directly to the mains via the first main switch 7. An alternating current switch 8A, 8B, 8C may optionally be arranged in the power supply of these components. In some embodiments, these components can also be activated and deactivated individually or as a group by means of individual alternating current switches 8A, 8B, 8C. The alternating current switches are optionally constructed as solid-state relays or as mechanical relays.

Optionally, the microscope system 1 comprises a control box 11 in which the control unit 10 is housed. In some embodiments, further elements for controlling, and supplying power to, the components of the microscope system 1 are housed in the control box 11. Optionally, the elements are accommodated in the control box 11 in an EMC-compliant manner and are also optionally protected against contamination and moisture. In some embodiments, the power supply unit 6, the direct current switches 9A, 9B, 90, 9D, 9E as well as the alternating current switches 8A, 8B, 8C and the first main switch 7 as well as the cabling of these elements are arranged in the control box 11, in addition to the control unit 10. Optionally, control units of the direct current loads and/or at least some of the direct current loads are also arranged in the control box 11. In at least one embodiment, the control box 11 comprises electric interfaces, in particular plug connections, with which an electric connection to the direct current loads and/or to the alternating current loads and their respective power supply can be established. The control box 11 can be arranged on or in a housing of the microscope system 1 or, in particular, on or in a housing of the optical microscope unit 2.

The direct current switches and the alternating current switches are optionally constructed in a network-compatible manner and can be controlled by the control unit 10 via a corresponding network 15B, in particular an I2C SPI or CAN bus. For this purpose, the control unit 10 optionally comprises a data memory 13, in which a control file 14 can be stored. The direct current switches and/or the alternating current switches are switched on the basis of this control file 14, in which criteria and/or a temporal sequence for switching the direct current switches and/or the alternating current switches are stored.

Via a further network connection 15A, in particular in a wireless or wired manner, or via a USB connection 16, the control unit 10 can be connected to a stationary computer 12A and/or to a mobile terminal 12B, such as for example to what is referred to as a tablet computer, in a signal-transmitting manner. In some embodiments, a LAN interface or a Wi-Fi interface 23 and/or a USB interface 24 is provided on the control box 11 for this purpose. In this context, the stationary computer 12A and/or the mobile terminal 12B may optionally have their own, third power supply 20.

Commands for switching on and/or switching off the at least one alternating current load and the at least one direct current load can be given to the control unit 10 by means of the stationary computer 12A or the mobile terminal 12B. These commands are optionally implemented directly by the control unit 10. In addition, the stationary computer 12A or the mobile terminal 12B can be used to write to the control file 14 of the control unit 10. In this way, the predefined criteria or the sequence for switching the loads on or off can be changed.

Conversely, the control unit 10 can give commands to the stationary computer 12A and/or to the mobile terminal 12B to wake up from a sleep mode.

As shown in FIG. 1, a microscope arrangement can comprise further devices that interact with the microscope system 1. In the case shown, this is a confocal microscope 4D. This is supplied with electric power via a second power supply 19 and a second main switch 17 as well as a power control system 8D. In this context, in some embodiments, the power control system 8D is constructed as an alternating current switch. The power control system 8D as well as the second main switch 17 may optionally be arranged in a second control box 21. In addition, the power control system 8D is connected to the control unit 10 in a signal-transmitting manner by means of the network 15B. In this way, the control unit 10 can switch the power control system 8D as well.

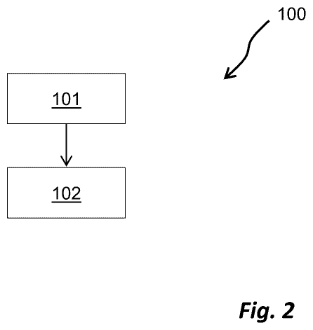

FIG. 2 shows a flowchart of a method 100 for operating a microscope system 1.

In a first method step 101, the various loads are switched on by the control unit in a predefined switch-on sequence. In this context, the predefined switch-on sequence is selected in such a way that the loads find each other.

In a second method step 102, the various loads are switched off by the control unit 10 in a predefined switch-off sequence. In at least one embodiment, the switch-off sequence is inverse to the switch-on sequence. For example, the definite focus unit is optionally switched on after the stand, and/or the definite focus unit is switched on after the control unit 10. Further, in some embodiments, according to the switch-off sequence, the stand is switched off after the definite focus unit, and/or the control unit 10 is switched off after the definite focus unit.

Optionally, the control unit 10 comprises corresponding means in order to carry out the control functions and/or the method 100 mentioned above.

Within the meaning of the present disclosure, such a means can optionally be implemented in terms of hardware and/or software and can in particular comprise a processing unit, in particular a microprocessor unit (CPU), in particular a digital processing unit, in particular a digital microprocessor unit (CPU), optionally one that is connected to a memory system and/or a bus system in a manner that permits the transmission of data and/or signals, and/or can comprise one or more programs or program modules. The microprocessor unit can be constructed in order to execute instructions that are implemented as a program stored in a memory system, to acquire input signals from a data bus and/or to send output signals to a data bus. A memory system can comprise one or more storage media, in particular different storage media, in particular optical, magnetic, solid-state and/or other non-volatile media. The program can be of such nature that it embodies, or is capable of executing, the methods described herein, so that the microprocessor unit can carry out the steps of such methods.

It is to be understood that the term “means” as used herein shall be interpreted as broadly as possible. Accordingly, the term “means” extends to any structures, materials or acts set forth herein, as well as any equivalents thereof. Further, the structures, materials or acts and equivalents thereof encompass anything that is described in the summary, the brief description of the drawings, the detailed description, the abstract and the claims themselves. The control unit and/or means thereof can optionally take the form of a variant of only hardware, a variant of only software (including firmware, resident software, microcode, etc.), or a combination of software and hardware aspects, which are generally referred to herein as a “circuit”, “module” or “system”. Any combination of one or more computer readable media may be used. The computer readable medium can be a computer readable signal medium or a computer readable storage medium.

The systems and methods according to the disclosure can optionally be implemented in conjunction with a suitably set up computer, a programmed microprocessor or microcontroller and one or more peripheral integrated circuit elements, an ASIC or a different integrated circuit, a digital signal processor, a hardwired electronic or logic circuit such as for example a circuit with discrete elements, a programmable logic device or gate array, such as for example a programmable logic device (PLD), a programmable logic array (PLA), a field programmable gate array (FPGA), a programmable logic array (PAL), or a comparable means. In general, any apparatus or means which are capable of implementing the methodology set forth herein can be used to implement the various aspects of the present disclosure. Example hardware includes computers, handheld devices, telephones (for example cellular, Internet-enabled, digital, analog, hybrid, and others), and other hardware known in the art. Some of these devices include processors (for example a single microprocessor or multiple microprocessors), storage devices, non-volatile storage devices, input devices and output devices. In addition, alternative software implementations, including, but not limited to, distributed processing or distributed processing of components/objects, parallel processing, or processing by virtual machines, can be developed in order to implement the methods which are described herein.

It is to be noted that the example embodiments are merely examples which are not intended to restrict the scope of protection, the application and the structure in any way. Rather, the preceding description provides the skilled person with a guideline for the implementation of at least one example embodiment, whereby various changes, in particular with regard to the function and arrangement of the components described, can be carried out without departing from the scope of protection as it results from the claims and combinations of features which are equivalent to these.

While various embodiments of the present disclosure have been described in detail, it is apparent that modifications and alterations of those embodiments will occur to those skilled in the art. However, it is to be understood that such modifications and alterations are within the scope and spirit of the present disclosure, as set forth in the following claims. Further, the disclosure described herein is capable of other embodiments and of being practiced or of being carried out in various ways. It is to be understood that the phraseology and terminology used herein is for the purpose of description and should not be regarded as limiting.

A number of variations and modifications of the disclosure can be used. It would be possible to provide for some features of the disclosure without providing others. The present disclosure, in various embodiments, configurations, or aspects, includes components, methods, processes, systems and/or apparatus substantially as depicted and described herein, including various embodiments, configurations, aspects, subcombinations, and subsets thereof. Those of skill in the art will understand how to make and use the present disclosure after understanding the present disclosure. The present disclosure, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease and\or reducing cost of implementation.

The foregoing discussion of the disclosure has been presented for purposes of illustration and description. The foregoing is not intended to limit the disclosure to the form or forms disclosed herein. In the foregoing Detailed Description for example, various features of the disclosure are grouped together in one or more embodiments, configurations, or aspects for the purpose of streamlining the disclosure. The features of the embodiments, configurations, or aspects of the disclosure may be combined in alternate embodiments, configurations, or aspects other than those discussed above. This method of disclosure is not to be interpreted as reflecting an intention that the claimed disclosure requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the disclosure.

Moreover, though the description of the disclosure has included description of one or more embodiments, configurations, or aspects and certain variations and modifications, other variations, combinations, and modifications are within the scope of the disclosure, e.g., as may be within the skill and knowledge of those in the art, after understanding the present disclosure. It is intended to obtain rights which include alternative embodiments, configurations, or aspects to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

In one embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or very-large-scale-integration (VLSI) design. Whether software or hardware is used to implement the systems in accordance with this disclosure is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this disclosure can be implemented as program embedded on personal computer such as an applet, JAVA® or computer-generated imagery (CGI) script, as a resource residing on a server or computer workstation, as a routine embedded in a dedicated measurement system, system component, or the like. The system can also be implemented by physically incorporating the system and/or method into a software and/or hardware system.

Although the present disclosure describes components and functions implemented in the aspects, embodiments, and/or configurations with reference to particular standards and protocols, the aspects, embodiments, and/or configurations are not limited to such standards and protocols. Other similar standards and protocols not mentioned herein are in existence and are considered to be included in the present disclosure. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present disclosure.

The term “bus” and variations thereof, as used herein, can refer to a subsystem that transfers information and/or data between various components. A bus generally refers to the collection communication hardware interface, interconnects, bus architecture, standard, and/or protocol defining the communication scheme for a communication system and/or communication network. A bus may also refer to a part of a communication hardware that interfaces the communication hardware with the interconnects that connect to other components of the corresponding communication network. The bus may be for a wired network, such as a physical bus, or wireless network, such as part of an antenna or hardware that couples the communication hardware with the antenna. A bus architecture supports a defined format in which information and/or data is arranged when sent and received through a communication network. A protocol may define the format and rules of communication of a bus architecture.

The terms “computer-readable medium”, “memory” and variations thereof as used herein refers to any tangible storage and/or transmission medium that participates in providing instructions to a processor for execution. Such a medium may take many forms, including but not limited to, non-volatile media, volatile media, and transmission media. Non-volatile media includes, for example, non-volatile random access memory (NVRAM), or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, a compact disc read only memory (CD-ROM), any other optical medium, punch cards, paper tape, any other physical medium with patterns of holes, a random access memory (RAM), a programmable read only memory (PROM), and erasable programmable read only memory EPROM, a FLASH-EPROM, a solid state medium like a memory card, any other memory chip or cartridge, a carrier wave as described hereinafter, or any other medium from which a computer can read. A digital file attachment to an e-mail or other self-contained information archive or set of archives is considered a distribution medium equivalent to a tangible storage medium. When the computer-readable media is configured as a database, it is to be understood that the database may be any type of database, such as relational, hierarchical, object-oriented, and/or the like. Accordingly, the disclosure is considered to include a tangible storage medium or distribution medium and prior art-recognized equivalents and successor media, in which the software implementations of the present disclosure are stored. It should be noted that any computer readable medium that is not a signal transmission may be considered non-transitory.

Examples of the processors as described herein may include, but are not limited to, at least one of Qualcomm® Snapdragon® 800 and 801, Qualcomm® Snapdragon® 610 and 615 with 4G LTE Integration and 64-bit computing, Apple® A7 processor with 64-bit architecture, Apple® M7 motion coprocessors, Samsung® Exynos® series, the Intel® Core® family of processors, the Intel® Xeon® family of processors, the Intel® Atom™ family of processors, the Intel Itanium® family of processors, Intel® Core® i5-4670K and i7-4770K 22 nm Haswell, Intel® Core® i5-3570K 22 nm Ivy Bridge, the AMD® FX™ family of processors, AMD® FX-4300, FX-6300, and FX-8350 32 nm Vishera, AMD® Kaveri processors, Texas Instruments® Jacinto C6000™ automotive infotainment processors, Texas Instruments® OMAP™ automotive-grade mobile processors, ARM® Cortex™-M processors, ARM® Cortex-A and ARM926EJ-S™ processors, other industry-equivalent processors, and may perform computational functions using any known or future-developed standard, instruction set, libraries, and/or architecture.

To provide additional background, context, and to further satisfy the written description requirements of 35 U.S.C. § 112, the following references are incorporated by reference herein in their entireties: U.S. Pat. No. 5,668,660A, German Patent Publication DE 10355529A1, and Japan Patent Publication JP 2009-217120A.

### LIST OF REFERENCE SIGNS

1 microscope system
2 optical microscope unit
3 first power supply
4A, 4B, 4C, 4D alternating current load
5A, 5B, 5C, 5D, 5E direct current load
6 power supply unit
7 first main switch
8A, 8B, 8C alternating current switch
9A, 9B, 9C, 9D, 9E direct current switch
10 control unit
11 control box
12 A, 12 B computer system
13 data memory
14 control file
15A, 15B network
16 USB bus
17 second main switch
18 power grid
19 second power supply
20 third power supply
21 second control box
22 electric interface
23 LAN interface or Wi-Fi interface
24 USB interface

1. A microscope system for analyzing samples, comprising:
an optical microscope unit;
a first power supply for mains electric power;
at least one alternating current load which is supplied with mains electric power via the first power supply;
a plurality of direct current loads;
a power supply unit which is set up to convert the mains electric power from the first power supply into direct current, wherein the direct current loads are supplied with direct current via the power supply unit; and
a first mains electric switch, which is arranged in the first power supply and which is set up to interrupt the mains electric power for the at least one alternating current load and the power supply unit.

2. The microscope system according to claim 1, further comprising:
at least one alternating current switch which is set up to interrupt the mains electric power for the at least one alternating current load; and
at least one direct current switch, which is set up to interrupt the direct current for the plurality of direct current loads.

3. The microscope system according to claim 2, further comprising:
a control unit, which is supplied with direct current via the power supply unit and which is connected to the at least one alternating current switch and the at least one direct current switch in a manner which enables the transmission of signals, and wherein the control unit is set up to switch the at least one alternating current switch and the at least one direct current switch.

4. The microscope system according to claim 1, further comprising a control box, wherein the first mains electric switch, the power supply unit, a control unit, at least one direct current switch and at least one of the components from the following group of components are arranged in the control box: control devices of the direct current loads, at least one alternating current switch, and at least one of the plurality of direct current loads.

5. The microscope system according to claim 3, wherein the control unit can be connected to a computer system in a manner which enables the transmission of signals and wherein the control unit is set up to start up and shut down the computer system.

6. The microscope system according to claim 3, wherein the control unit comprises a data memory in which a relative and/or absolute temporal sequence for switching on and/or for switching off the at least one alternating current load and the plurality of direct current loads is stored, and wherein the control unit switches the at least one alternating current switch and the at least one direct current switch on the basis of the temporal sequence.

7. The microscope system according to claim 6, wherein the control unit can be connected to a computer system in a manner which enables the transmission of signals and wherein the temporal sequence can be set by means of the computer system.

8. The microscope system according to claim 1, wherein the at least one alternating current load is selected from the following group of alternating current loads:
a first light, a second light, an XY stage with a controller, an incubation unit, a manipulation unit for microscopic samples, equipment for electrophysiology, and a laser microscope unit.

9. The microscope system according to claim 1, wherein at least one of the plurality of direct current loads is selected from the following group of direct current loads:
a stand, a focus drive, a trigger unit, a definite focus unit, an auto-immersion unit, a third light, and a piezo focus unit.

10. A microscope arrangement, comprising:
a microscope system according to claim 1, further comprising a further load supplied with mains electric power via a second power supply and which has a second switch, wherein the second switch is arranged in the second power supply, wherein a control unit is connected to the second switch in a manner which enables the transmission of signals, and wherein the control unit is set up to switch the second switch.

11. A method of operating a microscope system according to claim 3, wherein a predefined switch-on sequence is maintained when various loads of the at least one alternating current load and the plurality of direct current loads are switched on by the control unit, in such a way that the at least one alternating current load and the plurality of direct current loads can find each other.

12. The method of claim 11, wherein a predefined switch-off sequence is maintained when the various loads are switched off by the control unit.

13. The method of claim 12, wherein the switch-off sequence is inverse to the switch-on sequence.

14. A method of operating a microscope arrangement according to claim 10, wherein a predefined switch-on sequence is maintained when various loads of the at least one alternating current load and the plurality of direct current loads are switched on by the control unit, in such a way that the at least one alternating current load and the plurality of direct current loads can find each other.

15. The method of claim 14, wherein a predefined switch-off sequence is maintained when the various loads are switched off by the control unit.

16. The method of claim 15, wherein the switch-off sequence is inverse to the switch-on sequence.

17. The microscope system according to claim 2, wherein:
a separate alternating current switch of the at least one alternating current switches is provided for each of the at least one alternating current load; and/or
a separate direct current switch of the of the at least direct current switches is provided for each of the plurality of direct current loads.

18. A microscope arrangement, comprising:
a microscope system according to claim 3, further comprising a further load supplied with mains electric power via a second power supply and which has a second switch, wherein the second switch is arranged in the second power supply, wherein the control unit is connected to the second switch in a manner which enables the transmission of signals, and wherein the control unit is set up to switch the second switch.

19. The microscope system according to claim 3, wherein the control unit is connected to the at least one alternating current switch and the at least one direct current switch in a manner which enables the transmission of signals via an I2C, an SPI or a CAN bus.

20. The microscope system according to claim 4, wherein all of the components of the following group are arranged in the control box: control devices of the direct current loads, the at least one alternating current switch, and at least one of the plurality of direct current loads.
